(19) United States
(12) Patent Application Publication
(10) Pub. No.: US 2016/0309249 A1
(43) Pub. Date: Oct. 20, 2016

(54) WEARABLE ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: SHU-QI WU, Wuhan (CN); YONG-CHANG FAN, Wuhan (CN); YU-LIN LIU, Wuhan (CN)

(21) Appl. No.: 14/699,851

(22) Filed: Apr. 29, 2015

(30) Foreign Application Priority Data
Apr. 16, 2015 (CN) 201510180192.3

(51) Int. Cl. H04R 1/10

(52) U.S. Cl. CPC H04R 1/105; H04R 1/1016; H04R 1/1025

(57) ABSTRACT

A wearable electronic device includes an electronic device enclosure and a host. The electronic device enclosure includes a mounting portion defining a receiving hole. The mounting portion includes a clipping member movably received in the receiving hole. The host includes a host body and an earplug extending from the host body. The host body is rotatably attached to the mounting portion, the earplug is received in the receiving hole, and the clipping member is engaged with the earplug to prevent the earplug from disengaging from the receiving hole.

### FIELD

The subject matter herein generally relates to a wearable electronic device.

### BACKGROUND

Mobile electronic devices, such as mobile phones, media players, laptops, tablets, PDAs, or hybrid devices, provide a user with access to computing capabilities even as the user moves about various locations. A mobile electronic device can use a communication network to communicate with other electronic devices by Networks, for example, BLUETOOTH, WI-FI or TCP/IP. The electronic devices communicating with the mobile electronic device can be a wearable electronic device, such as a smart watch. When the wearable electronic device communicates with the mobile electronic device, the text, video data, audio data, user settings or other types of data in the mobile electronic device can be shown by the wearable electronic device.

### BRIEF DESCRIPTION OF THE DRAWINGS

Implementations of the present technology will now be described, by way of example only, with reference to the attached figures.

FIG. 1 is an exploded, isometric view of an embodiment of a wearable electronic device.

FIG. 2 is an isometric view of an embodiment of a host of the wearable electronic device of FIG. 1.

FIG. 3 is a block diagram of one embodiment of function modules of the wearable electronic device of FIG. 1.

FIG. 4 is an assembled view of the wearable electronic device of FIG. 1, showing the host opened.

FIG. 5 is similar to FIG. 4, showing the host closed

FIG. 6 is a cross-section view of FIG. 5, taken along a line VI-VI, and a clipping member extends out of a securing slot to clip with an earplug.

FIG. 7 is similar to FIG. 6, and the clipping member is received in the securing slot to disengage from the earplug.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a wearable electronic device. The wearable electronic device includes an electronic device enclosure and a host. The electronic device enclosure includes a mounting portion defining a receiving hole. The mounting portion includes a clipping member movably received in the receiving hole. The host includes a host body and an earplug extending from the host body. The host body is rotatably attached to the mounting portion, the earplug is received in the receiving hole, and the clipping member is engaged with the earplug to prevent the earplug from disengaging from the receiving hole.

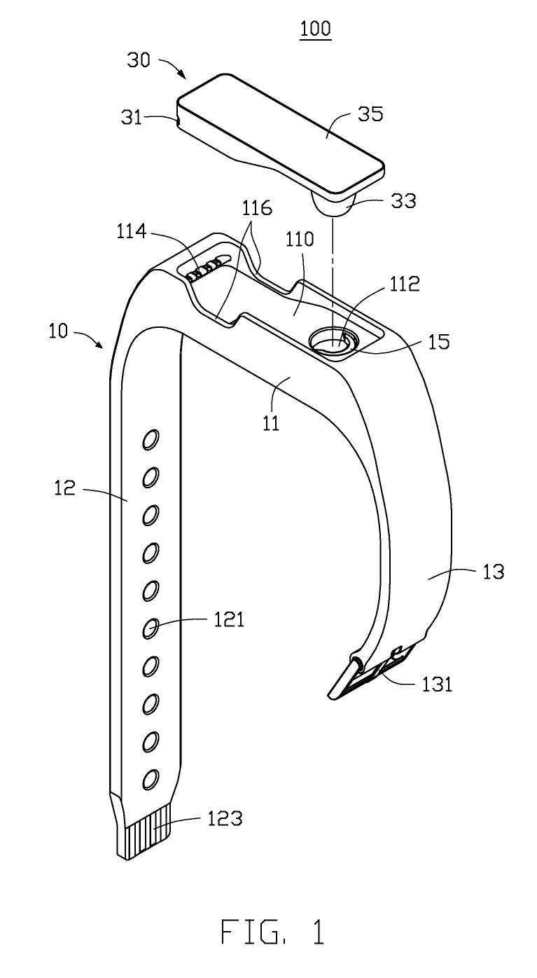

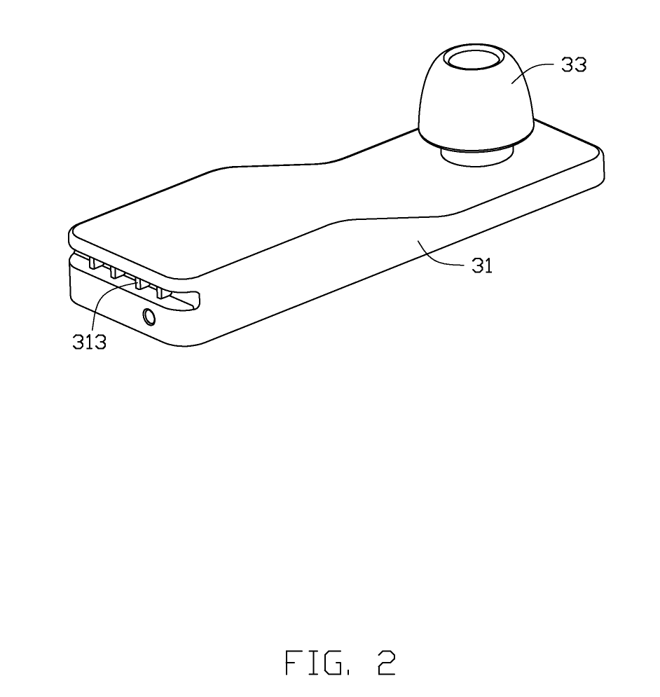

FIGS. 1-3 illustrate an embodiment of a wearable electronic device 100. The wearable electronic device 100 can include an electronic device enclosure 10 and a host 30 configured to be attached to the electronic device enclosure 10. In at least one embodiment, the wearable electronic device 100 has a call function and can be a smart watch, a smart phone, a tablet computer, a smart camera. In this embodiment, a smart watch can be provided.

The electronic device enclosure 10 can include a mounting portion 11, a first extending portion 12 extending from a first side of the mounting portion 11, and a second extending portion 13 extending from a second side of the mounting portion 13. In at least one embodiment, the first and second extending portions 12, 13 are two watch straps of the smart watch.

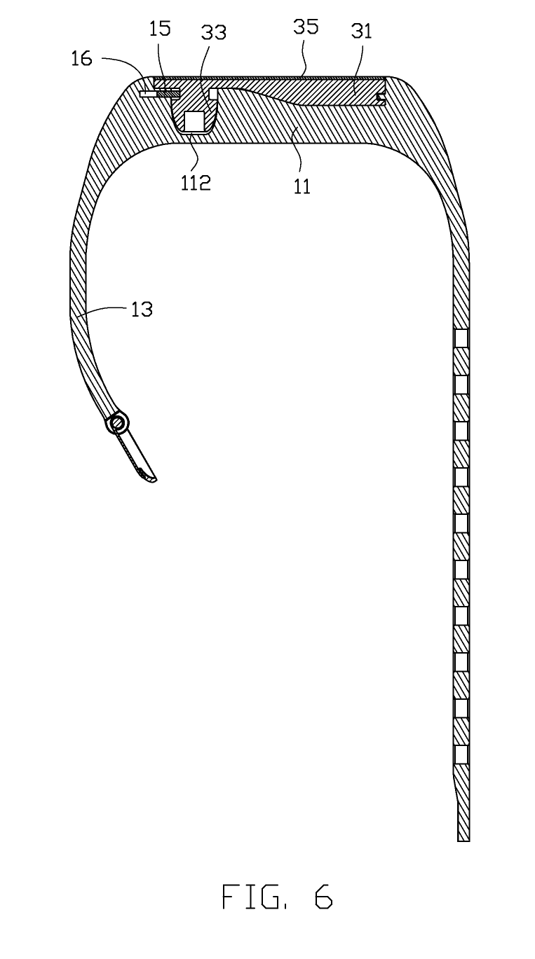

A receiving portion 110 can be located on the mounting portion 11. A receiving hole 112 is defined in a first end of the receiving potion 110, and a conductive socket 114 is located on a second end of the receiving portion 110. A clipping member 15 is moveably received in a securing slot 16 (see FIG. 6) defined in the mounting portion 11, and can be controlled to extend out of the securing slot 16. In at least one embodiment, the clipping member 15 can be coupled to a driving module 17 and can be driven by the driving module 17 to extend out of the securing slot 16. That is, when the host 30 is disengaged from the mounting portion 11, the clipping member 15 is received in the securing slot 16 and is away from the receiving hole 112; and when the host 30 is secured to the mounting portion 11, the clipping member 15 extends out of the securing slot 16 to be located in the receiving hole 112. A cutout 116 is defined in each side of the receiving portion 110.

The first extending portion 12 defines a plurality of engaging holes 121. A charge device 123, such as a universal serial bus (USB) port, is located on a distal end of the first extending portion 12 and is coupled to the conductive socket 14. Thus, when the charge device 123 is coupled to an electronic device (not shown), such as a computer, the electronic device 123 can supply power for the host 30. In at least one embodiment, the charger device 123 can be a wireless charger device that is located in the electronic device enclosure 10, and when the host 30 is secured to the electronic device enclosure 10, the wireless charge device can supply power for the host 30. A clamp 131 is located on a free end of the second extending portion 23 and is configured to any of the plurality of engaging holes 121.

The host 30 can include a host body 31, an earplug 33 extending from a bottom surface of the host body 31, and a touch screen 35 located on a top surface of the host body 31. The host body 31 can communicate with an electronic device (not shown) via networks, such as BLUETOOTH, WI-FI or TCP/IP. For example, the electronic device can be mobile phone. When a call or message is received by the mobile phone, the call or message can be shown on the touch screen 35. The host body 31 can include a control module 311 coupled to the driving module 17. The clipping member 15 can be moveable by the driving module 17 controlled by the control module 311. A conductive contact 313 is located on the host body 31 and is configured to be coupled to the conductive socket 114. The earplug 33 can be received in the receiving hole 112, and when the earplug 33 is received in the receiving hole 112, the clipping member 15 can extend out of securing slot 16 to engage with the earplug 33. A text, a video data, an audio data, user settings or other types of data, such as weather or schedule, can be shown on the touch screen 35.

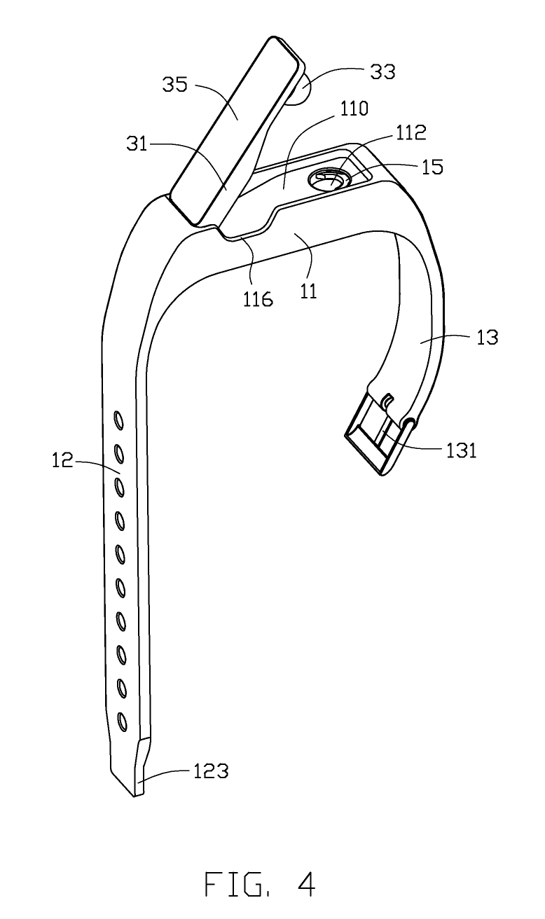

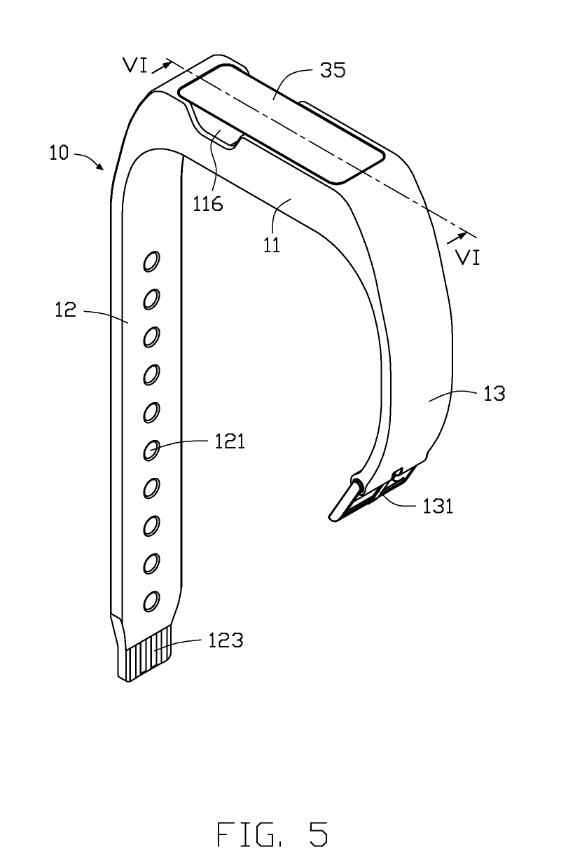

FIGS. 4-6 illustrate an embodiment of the wearable electronic device 100. In assembly, the host body 31 is located in the receiving portion 110, and the conductive contact 313 is coupled to the conductive socket 114. The host body 31 is rotated to engage the earplug 33 in the receiving hole 112. The control module 311 starts to work via the touch screen 35, for allowing the driving module 17 to move the clipping member 15 to extend out of the securing slot 16 to engage with the earplug 33. Therefore, the earplug 33 can be secured in the receiving hole 112.

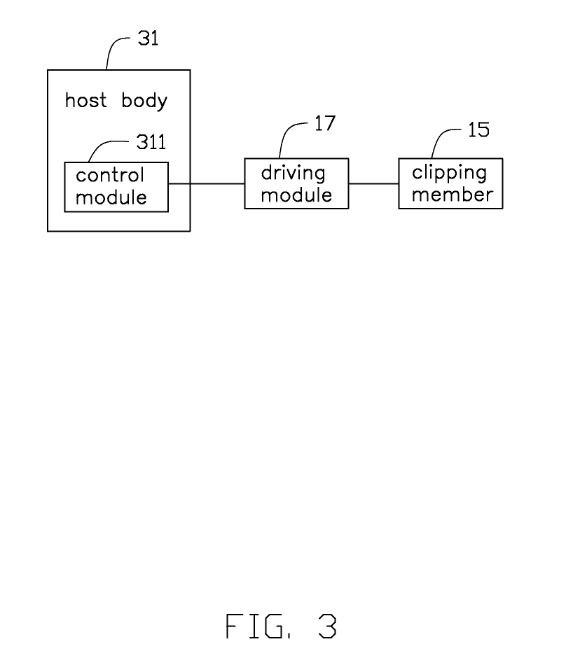

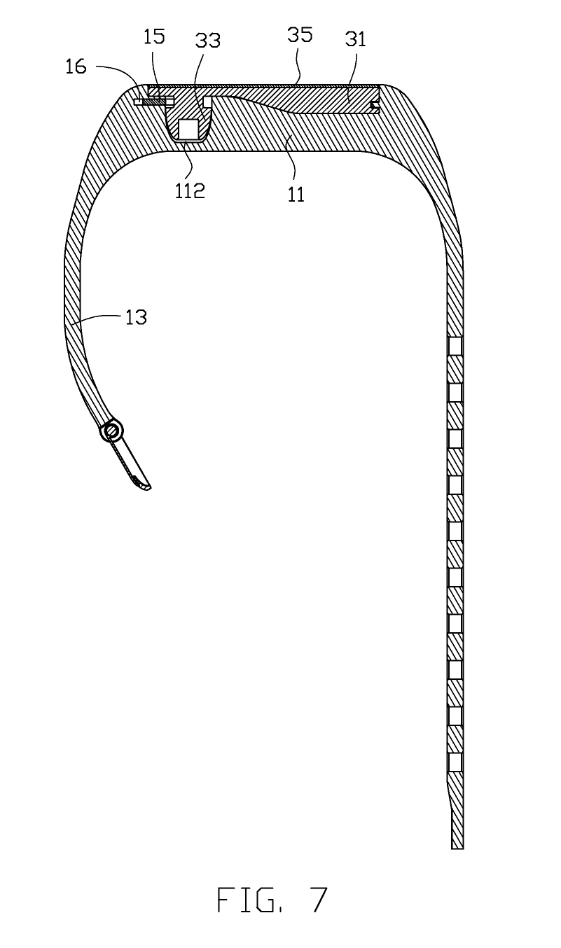

FIGS. 6-7 illustrate the wearable electronic device 100 being used. When the clamp 131 is engaged in one of the plurality of engaging holes 121, the charge device 123 can be located on an inside of the second extending portion 13. The host body 31 communicates with an electronic device (not shown) via networks, such as, BLUETOOTH, WI-FI or TCP/IP. When a call or message is received by the mobile phone, the call or message is shown on the touch screen 35 and can be read by a loudspeaker (not shown) on the host 30 (see FIG. 1). When an earphone function is needed by the host 30, the control module 311 (see FIG. 3) starts to work via the touch screen 35, allowing the driving module 17 to move the clipping member 15 to disengage from the earplug 33 to be received in the securing slot 16. The conductive contact 313 is disengaged from the conductive socket 114, and the host 30 can be removed from the receiving portion 11 via the two cutouts 116. Therefore, the host 30 can be a wireless earphone which communicates with the mobile phone.

When the host 30 needs to be charged, the conductive contact 313 is coupled to the conductive socket 114, and the charge device 123 can supply power for the host 30. That is, when the charge device 123 is a wireless charge device located in the electronic device enclosure 10, the charge device 123 can directly supply power for the host 30. When the charge device 123 is a USB port (see FIG. 1), the USB port can be coupled to the electronic device for allowing the electronic device to supply power for the host 30.

The embodiments shown and described above are only examples. Many details are often found in the art such as the other features of a electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A wearable electronic device comprising:
an electronic device enclosure comprising a mounting portion, a receiving hole defined therein, the mounting portion comprising a clipping member movably received in the receiving hole; and
a host comprising a host body and an earplug extending from the host body;
wherein the host body is rotatably attached to the mounting portion, the earplug is received in the receiving hole, and the clipping member is engagable with the earplug to prevent the earplug from disengaging from the receiving hole.

2. The wearable electronic device of claim 1, wherein the mounting portion defines a securing slot communicating with the receiving hole, and the clipping member is moveably received in the securing slot.

3. The wearable electronic device of claim 2, wherein the host body comprises a control module, and the control module is configured to move the clipping member to extend out of the securing slot or back to the securing slot.

4. The wearable electronic device of claim 1, wherein a charge device is located on the electronic device enclosure, and the charge device is configured to supply power for the host.

5. The wearable electronic device of claim 4, wherein the mounting portion further comprises a conductive socket coupled to the charge device, and the host body further comprises a conductive contact engaged with the conductive socket.

6. The wearable electronic device of claim 5, wherein the charge device is a universal serial bus (USB) port that is configured to be coupled to an electronic device.

7. The wearable electronic device of claim 6, wherein the wearable electronic device is a smart watch having a watch strap, and the USB port is located on an end of the watch strap.

8. The wearable electronic device of claim 7, wherein the host body further comprises a touch screen located on a top surface of the host body, the earplug extending from a bottom surface of the host body, and the touch screen is configured to show the information of a mobile electronic device that communicates with the host.

9. The wearable electronic device of claim 1, wherein the mounting portion defines two cutouts opposite to each other, and the host is detachable from the mounting portion by the two cutouts.

10. A wearable electronic device comprising:
an electronic device enclosure comprising a mounting portion; a conductive socket located on the mounting portion, and the mounting portion comprising a clipping member; and
a host comprising a host body, a touching screen located on a top surface of the host body, and an earplug extending from a bottom surface of the host body and engaged with the clipping member; a conductive contact located on the host body;
wherein the conductive contact is detachable engaged with the conductive socket, and the clipping member is moveable relative to the mounting portion to disengage from the earplug.

11. The wearable electronic device of claim 10, wherein the mounting portion defines a receiving hole, and the earplug is received in the receiving hole

12. The wearable electronic device of claim 11, wherein the mounting portion defines a securing slot communicating with the receiving hole, and the clipping member is moveably received in the securing slot.

13. The wearable electronic device of claim 12, wherein the host body comprises a control module, and the control module is configured to move the clipping member to extend out of the securing slot or back to the securing slot.

14. The wearable electronic device of claim 10, wherein a charge device is located on the electronic device enclosure, and the charge device is coupled to the conductive socket and is configured to supply power for the host.

15. The wearable electronic device of claim 14, wherein the charge device is a universal serial bus (USB) port that is configured to be coupled to an electronic device.

16. The wearable electronic device of claim 15, wherein the wearable electronic device is a smart watch having a watch strap, and the USB port is located on an end of the watch strap.

17. The wearable electronic device of claim 16, wherein the host body further comprises a touch screen located on a top surface of the host body, the earplug extending from a bottom surface of the host body, and the touch screen is configured to show the information of a mobile electronic device that communicates with the host.

18. The wearable electronic device of claim 10, wherein the mounting portion defines two cutouts opposite to each other, and the host is detachable from the mounting portion by the two cutouts.
